(19) United States
(12) Patent Application Publication
(10) Pub. No.: US 2025/0078517 A1
(43) Pub. Date: Mar. 6, 2025

(54) Public Safety Technology Scanner System and Related Methods

(71) Applicant: Yolanda Latrice Lyons, Winter Haven, FL (US)

(72) Inventor: Yolanda Latrice Lyons, Winter Haven, FL (US)

(21) Appl. No.: 18/241,918

(22) Filed: Sep. 4, 2023

(51) Int. Cl. G06V 20/56; G06F 3/041; H04W 4/18; H04W 4/40

(52) U.S. Cl. CPC G06V 20/56; G06F 3/0412; H04W 4/185; H04W 4/40

(57) ABSTRACT

The invention relates to a vehicular threat detection and occupant counting system, specifically tailored for police vehicles. Utilizing a combination of primary and scanning cameras, the system captures high-resolution and infrared data from the vehicle's surroundings. Integrated algorithms, built upon machine learning foundations, analyze the captured data for potential threats—emphasizing the detection of metallic objects—and for determining the count of vehicle occupants based on heat signatures. Results are promptly displayed on a user-friendly interface, allowing officers immediate insight into their surroundings. The system also includes capabilities for real-time data transfer to dispatch units, leveraging advanced connectivity modules and secure transmission protocols. Such a comprehensive approach ensures enhanced situational awareness, promotes officer safety, and aids in informed decision-making during field operations.

### CROSS REFERENCE TO RELATED APPLICATIONS

This patent application claims the benefit of US Provisional Patent Application No. U.S. 63/38,647, filed Jan. 26, 2023.

### FIELD OF INVENTION

The present invention pertains to vehicular threat detection systems, more particularly, to a system tailored for police vehicles that employs high-resolution and infrared cameras combined with machine learning algorithms to detect potential threats and count vehicle occupants.

### BACKGROUND

In recent years, as public and law enforcement interactions have come under increasing scrutiny, the need for technologies that enhance safety, transparency, and efficacy in such encounters has been accentuated. Traditionally, police officers have relied on visual observations, often under challenging and rapidly evolving situations, to make determinations about potential threats during vehicle stops. This reliance on human observation, while necessary, is fraught with the potential for error, misjudgment, and unfortunate consequences. The error rate is exacerbated during nighttime operations or in scenarios with poor visibility.

Several systems have been developed to aid officers in these situations, primarily dashboard cameras that record events in front of a police car. However, these cameras primarily serve a retrospective function, providing evidence after an event has transpired, rather than offering proactive, real-time insights that could prevent a potentially dangerous situation. Furthermore, these systems are limited in their scope, failing to identify hidden threats within a vehicle or accurately ascertain the number of occupants, crucial information that can greatly influence an officer's approach to a situation.

Additionally, existing systems largely operate in isolation, lacking real-time communication capabilities with dispatch units. This disconnect hampers rapid response and support in situations where every second can be pivotal. The shortcomings of these systems underscore the vital need for an integrated, technologically advanced solution that not only records events but also actively assists officers in threat assessment, real-time decision making, and communication.

The drive to develop the Public Safety Technology Scanner arises from these pressing needs and limitations. Recognizing the invaluable role that technology can play in bridging the gap between safety and operational efficacy, the present invention aims to transform the landscape of law enforcement interactions, ensuring protection for both the public and officers alike.

It is within this context that the present invention is provided.

### SUMMARY

The present invention, titled the Public Safety Technology Scanner, offers an integrated solution for law enforcement officers, aimed at enhancing public and officer safety during vehicle stops. Designed with a dual-camera system and coupled with advanced software capabilities, this invention brings forward real-time threat assessment, occupant detection, seamless communication with dispatch units, and more. With its placement on the dashboard of a police vehicle, it not only records events but actively analyzes the scene, providing crucial insights to the officers on duty.

In some embodiments, the invention incorporates a primary camera capable of capturing high-definition footage of the area in front of the police car. This camera is equipped with infrared capabilities, ensuring clear visibility under low-light conditions, and a high frame rate to capture fluid movements, making it suitable for both day and nighttime operations. Such a design advantageously provides officers with a comprehensive view of unfolding events, ensuring they are better informed during interactions.

In some embodiments, a specialized scanning camera is included. This camera uses X-ray or millimeter-wave technology to non-intrusively identify metallic threats such as guns, knives, and other potential weapons within another vehicle. The integration of such a system dramatically reduces reliance on officer judgment alone, thus potentially preventing escalation in situations where a hidden threat exists.

In some embodiments, the scanner also incorporates infrared sensors for occupant detection. By identifying and counting distinct heat signatures, the system can reliably inform officers of the number of individuals present in a vehicle. This feature addresses a key limitation of visual observations, ensuring officers are not caught off-guard by unseen occupants.

In some embodiments, the software of the scanner offers a threat detection algorithm built on a robust machine learning framework. It has been designed to learn and adapt over time, thereby ensuring the system remains relevant and up-to-date with emerging threats. Coupled with false positive management, this ensures accurate and dependable threat detection, significantly reducing the room for human error.

In some embodiments, the invention integrates real-time communication software, enabling secure and rapid data transfer between the device and dispatch units. This ensures that in high-risk situations, backup or additional resources can be dispatched in a timely manner, thus potentially reducing response times and increasing the safety of all involved parties.

In some embodiments, GPS logging software is included, automatically geotagging every piece of recorded data. This not only aids in evidence collection but also offers real-time location tracking, a feature that could prove invaluable in dynamic situations or pursuits.

### BRIEF DESCRIPTION OF THE DRAWINGS

Various embodiments of the invention are disclosed in the following detailed description and accompanying drawings.

FIG. 1 is a schematic view of the invention, illustrating the primary and scanning cameras in conjunction with the vehicle's onboard processing, storage, and connectivity modules.

FIG. 2 provides a block diagram representation of the internal architecture of the processing unit, highlighting the relationships between the hardware components and the embedded software modules.

FIG. 3 is a flowchart delineating the steps taken by the system, from data capture through primary and scanning cameras to the display of potential threats or occupant counts on the user interface, with optional data transfer steps based on detected threat levels.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present disclosure pertains to a Public Safety Technology Scanner specifically designed for law enforcement vehicles. The invention addresses the exigent need for enhanced real-time situational awareness, aiming to better equip officers in making informed decisions, particularly during traffic stops and other instances where the vehicle's surroundings and its occupants come under scrutiny.

The disclosed scanner system seamlessly integrates with police vehicles and comprises a multifaceted assembly of components. These components operate in concert to capture high-definition visual footage of a police vehicle's surroundings, conduct non-intrusive scans for potential threats within proximate vehicles, and allow officers to review and act upon the scanned data promptly.

Central to the system is a primary camera equipped for recording visual footage. This camera boasts advanced specifications, including high resolution, infrared capabilities, a high frame rate, and a broad field of view facilitated by a wide-angle lens. To complement the primary camera, a scanning camera fitted with specialized sensors-such as X-ray or millimeter-wave technology—and infrared sensors, detects metallic objects and counts vehicle occupants based on body heat.

To efficiently process, store, and communicate the data captured by the cameras, the scanner is furnished with a high-performance processing unit, quick Solid State Drive storage, and advanced connectivity modules. These components ensure real-time processing, secure storage, and immediate data transmission.

An intuitive user interface, encompassing a touchscreen display and a physical control panel, ensures that officers can operate the scanner with minimal delay, even under high-pressure scenarios. Advanced software underpins the hardware components. This includes a machine learning-based threat detection algorithm, occupant detection features, real-time communication software, GPS logging capabilities, a comprehensive data management system, and cloud integration.

Furthermore, the system places a premium on durability and resilience. Given the challenging and often unpredictable environments in which police vehicles operate, each hardware component has been meticulously designed and rigorously tested to ensure sustained performance under varied conditions.

By amalgamating high-tech hardware with sophisticated software, the invention provides law enforcement officers with a robust, real-time scanner that elevates situational awareness, potentially enhancing public safety and officer decision-making.

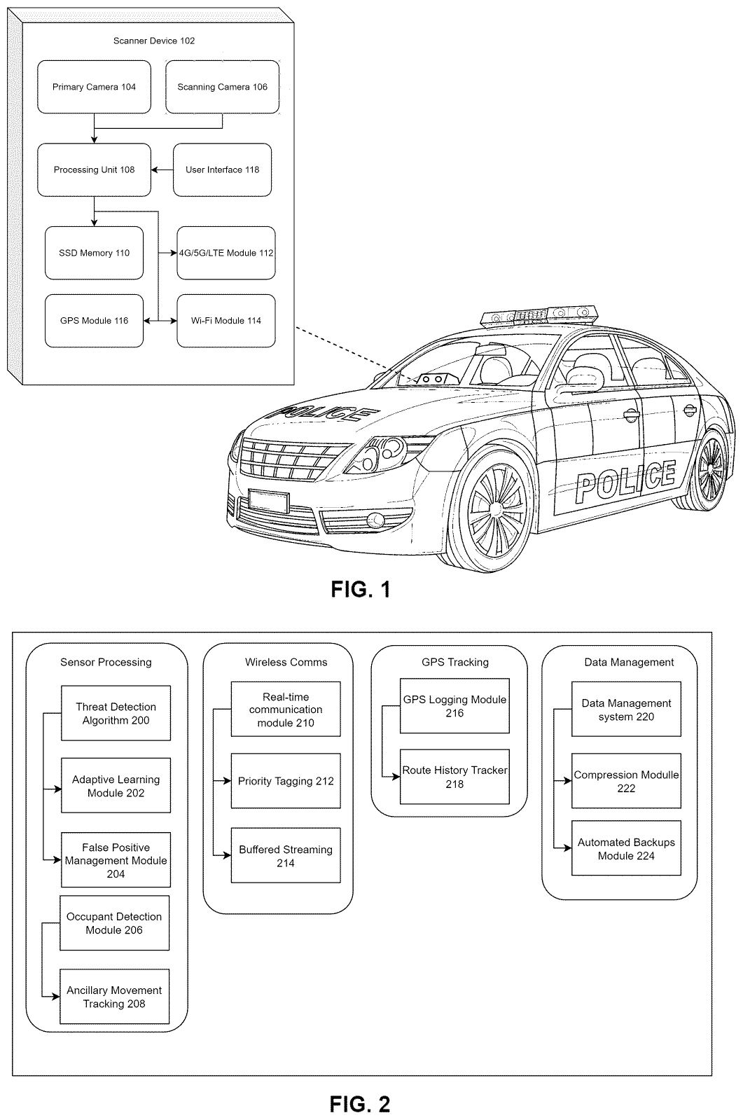

Referring now to FIG. 1, a block diagram illustrates the primary components and their interconnection within the public safety technology scanner system. The figure depicts a police vehicle 100 having an installed scanner device 102, positioned optimally on the dashboard for maximum efficacy.

Two distinct camera modules are shown, namely the primary camera 104 and the scanning camera 106. The primary camera 104, optimized for high-resolution image capture in varied environmental conditions, is oriented in a manner that grants a broad field of view. This ensures comprehensive coverage of the area in front of the police vehicle 100. The scanning camera 106, on the other hand, integrates both X-ray or millimeter-wave technology and infrared sensors. This combination allows the camera to non-intrusively detect metallic objects while also identifying heat signatures from occupants within a vehicle.

Centrally managing the processing of the captured data is the processing unit 108. This unit, comprising a high-speed multi-core processor, RAM, and a cooling system, undertakes real-time image processing, data analysis, and pertinent communication tasks. The robust configuration of the processing unit 108 ensures that large video files and threat detection algorithms can be handled simultaneously without performance degradation.

Data storage is facilitated by an SSD (Solid State Drive) 110, directly linked to the processing unit 108. The SSD 110 offers rapid read/write capabilities and enhanced durability, making it apt for the rigors of vehicle-based operations. Furthermore, the inherent encryption capabilities of the SSD 110 provide an added layer of security, ensuring that stored data remains safeguarded against unauthorized access.

For real-time communication and data transfer, a series of connectivity modules are presented atop the police vehicle 100. This includes a 4G/5G LTE module 112 and a dual-band Wi-Fi module 114. These modules ensure seamless data transfer, particularly crucial when transmitting large video files to a dispatch center or cloud storage. Additionally, a precise GPS module 116, also connected to the processing unit 108, offers real-time location tracking capabilities, ensuring that every piece of recorded data is duly geotagged with accurate coordinates.

The system further integrates a user interface 118 located within the police vehicle 100. The user interface 118 features a touchscreen display of a size ranging between 7 to 10 inches. This display permits officers to manually operate the device, either to view live scans or to review previously recorded footage. The rugged construction of the interface 118 guarantees its durability, allowing it to withstand occasional accidental drops or impacts. Adjacently located to the touchscreen are physical control buttons, offering critical functions like power management, manual recording initiation or cessation, and an emergency data send feature.

The arrangement and connection of these components within the scanner system are optimized for efficient and real-time operations. This design prioritizes the ability of law enforcement officers to promptly detect threats and analyze vehicle occupant data, thereby enhancing public safety and situational awareness.

Turning to FIG. 2, a schematic representation of the software components interfacing with the scanner system's hardware is provided. This figure elucidates the interrelation and functionality of various software modules that drive the efficient operation of the system.

Central to the software architecture is the threat detection algorithm 200. This algorithm employs a machine learning framework, leveraging the prowess of Convolutional Neural Networks (CNN) for the identification of weapons and potential threats based on parameters like shape, size, and material. Connected to the threat detection algorithm 200 is an adaptive learning module 202. This module facilitates the evolution and refinement of detection capabilities as it accumulates more data, ensuring adaptability to new or rare threats. Moreover, a false positive management module 204 is shown, which incorporates officer feedback mechanisms. This allows for the correction of the system's false identifications, consequently enhancing its accuracy over time

Another software module, the occupant detection algorithm 206, is depicted in proximity to the threat detection algorithm 200. This module leverages infrared data to identify and tally distinct heat signatures. It differentiates between humans and inanimate objects that emit heat. An ancillary movement tracking feature 208 is shown connected to the occupant detection algorithm 206. This feature is designed to identify and track the movement of heat sources, ensuring that dynamic scenarios, such as an individual's movement inside a vehicle, are accurately represented.

A real-time communication software module 210 interfaces directly with the hardware connectivity modules. This software ensures that data is transmitted securely via protocols like TLS or AES, guaranteeing protection from potential interception. Two additional sub-modules, priority tagging 212 and buffered streaming 214, are linked to the real-time communication software module 210. Priority tagging 212 facilitates the automatic labeling of footage when a threat is perceived or an officer flags an event. This ensures immediate dispatch review. On the other hand, buffered streaming 214 ensures data integrity during weak or interrupted connectivity, buffering the data and resuming transmission when stable connectivity is re-established.

A GPS logging software module 216, connected to the GPS hardware module, automates the geotagging of every recorded data piece with precise coordinates. Additionally, a route history feature 218 provides retrospective analysis of the police vehicle's navigated routes over designated durations.

Integral to data management is the data management system 220, connected to the onboard SSD storage. This system utilizes relational databases for efficient storage, organization, and data retrieval. Accompanying this system are the compression module 222, which reduces storage space requirements and expedites transmission, and the automated backups module 224, ensuring regular data replication to both onboard storage and cloud servers.

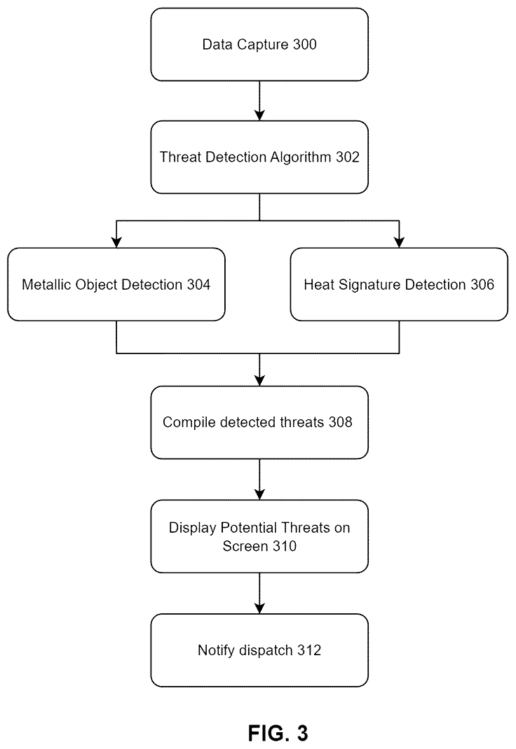

Referring to FIG. 3, the flowchart delineates a methodological process for threat detection and occupant counting. Each step in the flowchart is designed to ensure a systematic and efficient sequence from data capture to notifying the officer of potential threats or occupant counts.

The process begins with Step 300, wherein data is captured from the surroundings of a police vehicle using both primary and scanning cameras. This step ensures a comprehensive acquisition of visual data, including infrared readings necessary for subsequent analysis.

Upon successful data capture in Step 300, the process advances to Step 302, where the captured data is subjected to the threat detection algorithm. This algorithm, imbued with machine learning capabilities, parses the data in real-time, preparing it for more specialized analysis.

From Step 302, the process diverges into two parallel pathways:

Step 304 focuses on detecting metallic objects within the captured data. By examining visual patterns and signatures associated with metals, this step ascertains the presence of potential threats, especially those that might be metallic in nature, like firearms or sharp weapons.

Concurrently, Step 306 processes the infrared data to identify and count heat signatures within the target area. The algorithm's prowess at this stage is crucial for differentiating between human heat signatures and other heat sources, ensuring an accurate count of vehicle occupants.

Following the bifurcated analysis, the process reconverges at Step 308. At this juncture, the results—both potential threats and occupant counts—are prepared for display.

Step 310 represents the officer's interface where the aforementioned results are prominently and intuitively displayed. Any detected threats are highlighted for immediate attention, while occupant counts are presented in an easily digestible format.

The process concludes with an optional Step 312. Depending on the severity or nature of the detected threats, the system decides whether to forward this data to dispatch for further scrutiny or to store it for future reference. This decision-making step ensures that high-priority threats are escalated for immediate response, while lesser concerns are logged for potential later review.

### Network Components

A server as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and methods have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A public safety system, comprising:
a dual-camera module configured for placement on a dashboard of a police vehicle, wherein one camera is purposed for recording high-definition visual footage of a proximal environment and the other camera is specialized for scanning interiors of a vehicle to detect metallic objects, said scanning achieved through utilization of X-ray or millimeter-wave technology;
an infrared sensor associated with said dual-camera module, designed to identify and count distinct heat signatures for the purpose of detecting occupants within the said vehicle;
a processing unit, operatively connected to the dual-camera module, configured to receive and analyze data from both cameras, wherein said processing unit includes a machine learning framework capable of identifying potential threats based on the data from the scanning camera and counting the number of detected heat signatures from the infrared sensor;
a communication software component embedded within the processing unit, enabling secure data transmission between the system and an external dispatch unit;
a GPS logging component integrated into the system, operative to geotag recorded data with precise geographic coordinates; and
a user interface, operatively connected to the processing unit, allowing a user to interact with, configure, and retrieve data from the system.

2. The system of claim 1, wherein the camera configured for recording visual footage is equipped with 4K or higher resolution, infrared illuminators for low-light conditions, a frame rate of at least 60 fps, a wide-angle lens, and is constructed for resilience against environmental conditions.

3. The system of claim 1, wherein the scanning camera comprises X-ray or millimeter-wave technology sensors, an additional infrared sensor for heat signature detection, and a zoom capability for focused inspection.

4. The system of claim 1, wherein the processing unit is fortified with a high-speed multi-core processor, a minimum of 8 GB RAM, and an incorporated cooling system to prevent overheating.

5. The system of claim 1, further comprising a storage component employing a Solid State Drive, said drive being characterized by rapid data read/write capabilities, resilience against physical jolts, and embedded hardware encryption for data security.

6. The system of claim 1, further comprising connectivity modules including a 4G/5G LTE module, a dual-band Wi-Fi module, and an accurate GPS chipset for real-time location determination.

7. The system of claim 1, wherein the power supply integrates seamlessly with the police vehicle's electrical framework, supplemented by a backup battery designed for a minimum of 8 hours of operation.

8. The system of claim 1, wherein the user interface boasts a touchscreen display between 7 to 10 inches, ruggedized against potential damage, coupled with a control panel composed of physical buttons for critical system operations.

9. The system of claim 1, wherein the processing unit employs a machine learning framework, specifically leveraging Convolutional Neural Networks (CNN), trained for threat identification based on object characteristics, supplemented by adaptive learning and false positive management features.

10. The system of claim 1, further characterized by its infrared data processing ability that employs algorithms to differentiate and count distinct heat signatures, coupled with movement tracking of said heat sources.

11. The system of claim 1, wherein the communication software component ensures secure data transmission through protocols like TLS or AES, incorporates priority tagging and buffered streaming functionalities.

12. The system of claim 1, wherein the GPS logging software provides real-time geotagging for every piece of recorded data and maintains a route history for retrospective analysis.

13. The system of claim 1, further incorporating a data management system employing relational databases for efficient data storage and retrieval, integrated with compression capabilities and automated backup functions.

14. The system of claim 1, designed to integrate with cloud servers, providing functionalities like remote data storage, remote access by authorized personnel, and over-the-air system updates.
The system of claim 1, wherein the user interface software prioritizes intuitive design, offers customizable threat detection alerts, and maintains multi-tiered user access controls for data security.
